(19) United States
(12) Patent Application Publication
(10) Pub. No.: US 2014/0298123 A1
(43) Pub. Date: Oct. 2, 2014

(54) Scan Chain Reconfiguration and Repair

(71) Applicant: LSI CORPORATION, San Jose, CA (US)

(72) Inventor: Ramesh C. Tekumalla, Breinigsville, PA (US)

(73) Assignee: LSI Corporation, San Jose, CA (US)

(21) Appl. No.: 13/852,548

(22) Filed: Mar. 28, 2013

Related U.S. Application Data
(60) Provisional application No. 61/805,834, filed on Mar. 27, 2013.

(51) Int. Cl. G06F 11/26

(52) U.S. Cl. CPC G06F 11/26
USPC 714/726

(57) ABSTRACT

A system includes an integrated circuit. The integrated circuit includes at least one scan chain group. A particular scan chain group of the at least one scan chain group includes at least one scan chain and at least one spare scan chain. The at least one scan chain of the particular scan chain group includes a particular scan chain. The at least one spare scan chain of the particular scan chain group includes a particular spare scan chain. The particular spare scan chain is configured to bypass the particular scan chain.

### CROSS-REFERENCE TO RELATED APPLICATIONS

This application claims the benefit of U.S. Provisional Application No. 61/805,834, filed on Mar. 27, 2013.

### FIELD OF THE INVENTION

Embodiments of the invention are directed generally toward methods, systems, circuits, and apparati for production, testing, reconfiguration, and repair of integrated circuits or of circuitry of integrated circuits.

### BACKGROUND

Defects or inaccurate timing analysis during integrated circuit design and production can cause scan shift problems. Scan tests can fail in silicon because of inaccurate modeling of the analog logic in simulations. Defective scan chains in silicon can cause serious coverage and yield loss. Scan chain defects in integrated circuits can be very expensive. In some cases, such defects result in very low fault coverage and lead to very expensive respins of parts. Currently, the presence of a single defective scan chain on an integrated circuit can render an entire chip defective. Therefore, it would be desirable to provide a method and apparatus which reduce coverage loss, reduce yield impact, and reduce the cost of integrated circuit production.

### SUMMARY

Accordingly, an embodiment includes a system. The system includes an integrated circuit. The integrated circuit includes at least one scan chain group. A particular scan chain group of the at least one scan chain group includes at least one scan chain and at least one spare scan chain. The at least one scan chain of the particular scan chain group includes a particular scan chain. The at least one spare scan chain of the particular scan chain group includes a particular spare scan chain. The particular spare scan chain is configured to bypass the particular scan chain.

Additional embodiments are described in the application including the claims. It is to be understood that both the foregoing general description and the following detailed description are exemplary and explanatory only and are not restrictive. Other embodiments of the invention will become apparent.

### BRIEF DESCRIPTION OF THE FIGURES

Other embodiments of the invention will become apparent by reference to the accompanying figures in which:

FIG. 1 shows a diagram of an exemplary system which includes automatic test equipment and an integrated circuit chip;

FIG. 2 shows a diagram of an exemplary scan compression architecture;

FIG. 3A shows a diagram of scan compression architecture of an exemplary embodiment;

FIG. 3B shows a diagram of scan compression architecture of an additional exemplary embodiment; and

FIG. 4 shows a diagram of a system of an exemplary embodiment, which includes an integrated circuit and automatic test equipment.

### DETAILED DESCRIPTION OF THE INVENTION

Reference will now be made in detail to the subject matter disclosed, which is illustrated in the accompanying drawings. The scope of embodiments of the invention is limited only by the claims; numerous alternatives, modifications, and equivalents are encompassed. For the purpose of clarity, technical material that is known in the technical fields related to the embodiments has not been described in detail to avoid unnecessarily obscuring the description.

Embodiments of the invention include a method, an apparatus, a system, instructions configured to be executed by a computing device or processing module, and a circuit (e.g., an integrated circuit (such as microcircuits fabricated on a silicon substrate)). Some embodiments of the invention are configured to reroute scan compression logic such that scan chains with defects detected after silicon can be replaced by spare scan chains. Embodiments of the invention result in the recovery or increase of a significant amount of fault coverage. Further, embodiments reduce or potentially avoid occurrences of having to perform metal changes or to perform respins during integrated circuit production. Additionally, embodiments of the invention allow for integrated circuits with defective scan chains to be salvaged, and this improves the salvageable amount of fault coverage.

Defects or inaccurate timing analysis during integrated circuit design and production can cause scan shift problems. For example, inaccurate modeling of the analog logic in simulations can cause scan tests to fail in silicon. Broken scan chains in silicon can cause serious coverage and yield loss. Furthermore, alternative test generation with non-compression is very expensive. A number of other problems can arise in the post silicon stage of integrated circuit production. For example, potential problems include: timing marginalities, which may make some scan chains unusable; modeling deficiencies between silicon and simulation models; differences in assumptions between simulation models and silicon; drastic drop in defect coverage if some scan chains are defective; lack of design support which results in high defective parts per million; and in some cases, even a complete loss of scan coverage where the scan cannot be used at all.

Embodiments of the invention provide techniques to reduce coverage loss and to reduce negative impacts on the yield of functional silicon-based parts.

Embodiments of the invention include a spare scan chain for replacing one complete compression scan chain. Additionally, some embodiments include a spare flip flop for bypassing a defect or problem area in each scan chain. Some embodiments include the performance of compression mode chain replacement with little impact on fault coverage. Furthermore, some embodiments are configured to overcome failures or defects in multiple scan chains. Some embodiments are configured to bypass broken scan chains and reconfigure compression logic. Also, some embodiments allow for the ease of pattern regeneration without an impact on performance of failure diagnostics.

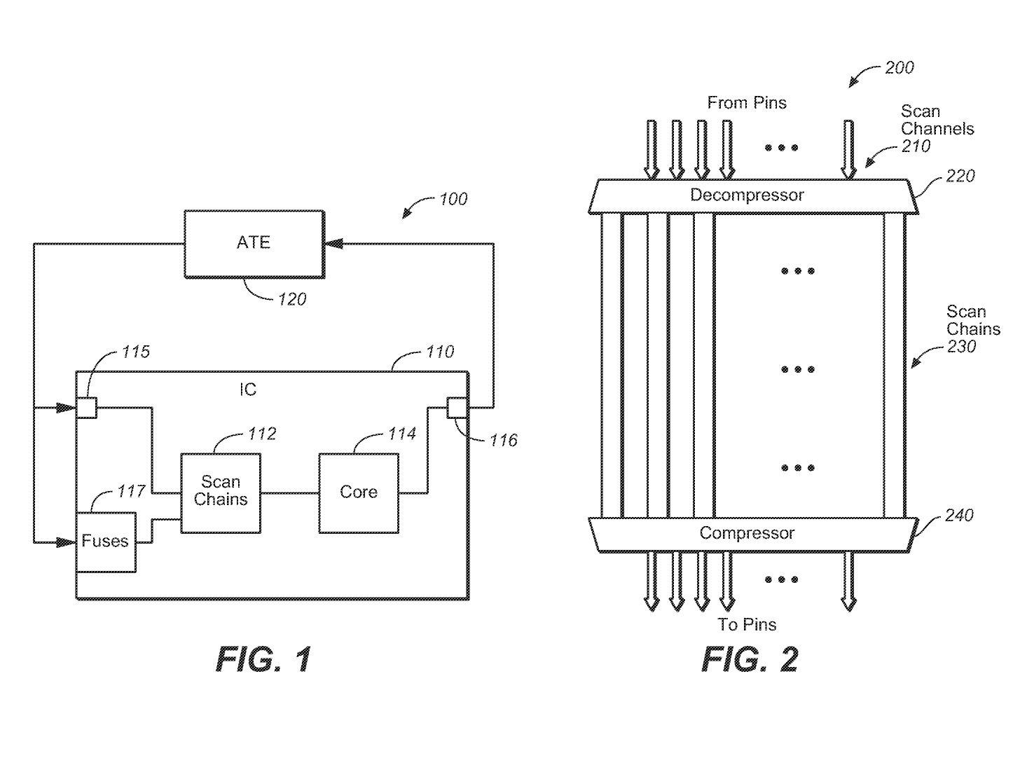

Referring now to FIG. 1, a diagram of an exemplary system 100 of some embodiments is depicted. The exemplary system 100 includes an integrated circuit chip 110 and automatic test equipment 120. The integrated circuit chip 110 includes a plurality of scan chains 112, a core 114 (e.g., core logic circuitry), pins 115, 116, and fuses 117. The automatic test equipment (ATE) 120 is configured to connect to pins 115, 116 of the integrated circuit chip 110. The ATE 120 is further configured to connect to pins corresponding to the fuses 117 of the integrated circuit chip 110. The ATE 120 is configured to test the integrated circuit 110 by sending scan inputs (e.g., generated test patterns) through the scan chains 112 of the integrated circuit chip 110. Based upon on scan outputs from the scan chains 112 as compared to expected functional scan output values, the ATE 120 determines whether any of the logic gates of the integrated circuit chip 110 is defective or likely to be defective. Additionally, if the ATE 120 determines that a scan chain is defective, the ATE 120 is configured to burn one or more of the fuses 117 which causes a spare scan chain to bypass a defective scan chain. While FIG. 1 depicts an exemplary embodiment with the fuses 117 being located in or on the integrated circuit 110, it is fully contemplated that in some embodiments the fuses are located elsewhere, such as in, on, or coupled to the ATE 120, another integrated circuit, a circuit board, coupled between the ATE 120 and the integrate circuit 110, or the like.

Referring now to FIG. 2, a diagram of an exemplary scan compression architecture 200 is depicted. The exemplary scan compression architecture 200 includes scan channels 210, a decompressor 220, a plurality of scan chains 230, and a compressor 240. The ATE 120 sends scan inputs through pins of an integrated circuit 110 to scan channels 210 of an integrated circuit 110. The decompressor 220 receives the scan inputs from the scan channels and decompresses test patterns of the scan inputs. The decompressor 220 then routes each of the decompressed scan inputs to a particular scan chain of the plurality of scan chains 230. Each of the plurality of scan chains 230 is associated with a particular portion of the logical circuitry of the integrated circuit chip 110. Running the test patterns of the scan inputs through each of the scan chains 230 produces a scan output with a particular value. The compressor 240 then receives the scan outputs from each of the plurality of scan chains 230. The compressor 240 compresses the scan outputs and sends the scan outputs via output scan channels to the ATE 120. The compressor 240 is configured to perform a compression algorithm to reduce the number of scan outputs sent to the ATE 240.

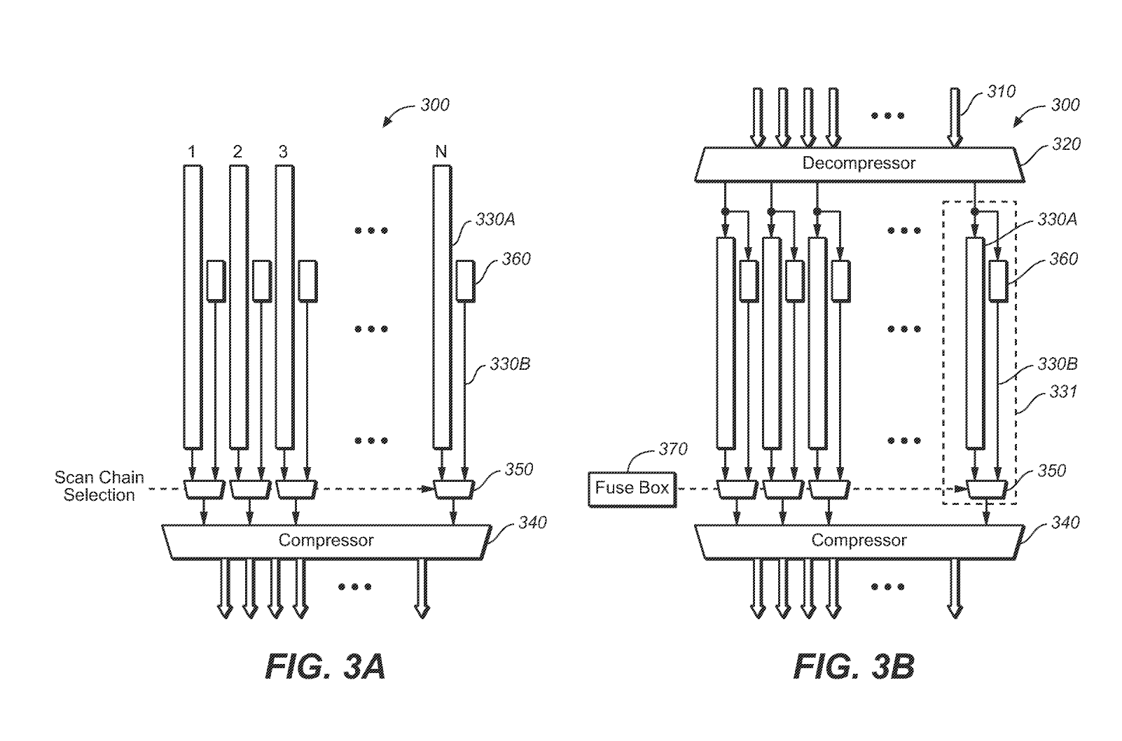

Referring now to FIGS. 3A-3B, exemplary diagrams of a portion of a circuit 300 (e.g., an integrated circuit) of some embodiments are depicted. In some embodiments, the circuit 300 includes a plurality of scan channels 310, a decompressor 320, a plurality of scan chains 330A, a plurality of spare scan chains 330B, a plurality of spare flip flops 360, a plurality of scan chain selection mechanisms (e.g., a plurality of multiplexers 350), a compressor 340, one or more cores or other processing modules (such as core 114 as shown in FIG. 1), and pins (such as pins 115, 116 as shown in FIG. 1). Referring to FIG. 3B, in some embodiments, the circuit 300 further includes a reconfiguration mechanism (e.g., a fuse box 370).

In some embodiments, the circuit 300 includes a plurality of scan chain groups 331. In some embodiments, a scan chain group 331 includes a scan chain 330A and a spare scan chain 330B, wherein a spare scan chain 330B can be selected to bypass the scan chain 330A. The scan chain 330A and the spare scan chain 330B are communicatively coupled on the scan-in side to the compressor 320 and communicatively coupled on the scan-out side to the compressor 340. In further embodiments, the scan chain group 331 also includes a spare flip flop 360; in such embodiments, the spare flip flop 360 is coupled between the scan chain 330A and the spare scan chain 330B. In some embodiments which include an implementation with a spare flip flop 360, the scan chain group 331 includes only one spare flip flop 360; in other embodiments, the scan chain group includes two or more spare flip flops. In still further embodiments, the scan chain group 331 also includes a scan chain selection mechanism (e.g., multiplexer 350); in such embodiments, the scan-out sides of the scan chain 330A and the spare scan chain 330B are coupled to the scan chain selection mechanism (e.g., multiplexer 350), which is coupled to the compressor 340. As exemplarily shown in FIGS. 3A-B, each scan chain 330A is multiplexed with its corresponding spare scan chain 330B. As exemplarily shown in FIGS. 3A-B, the multiplexer 350 operates as a scan chain selection mechanism configured to select or change which scan chain of a particular scan chain group to use or bypass; in some embodiments, the multiplexer 350 selects or changes the use of a scan chain based upon the automatic test equipment burning one or more fuses of the fuse box 370.

In some embodiments, the automatic test equipment sends scan inputs through pins and scan channels 310 of the circuit 300. The decompressor 320 receives the scan inputs from the scan channels 310 and decompresses test patterns of the scan inputs. In some embodiments, the decompressor 220 then routes each of the decompressed scan inputs to a particular scan chain group 331. Each of the plurality of scan chain groups 331 is associated with a particular portion of the logical circuitry (e.g., one or more logical gates) of the circuit 300; that is, each spare scan chain 330B and the corresponding scan chain 330A of the scan chain group 331 are associated with a particular portion of the logical circuitry of the circuit 300. Running the test patterns of the scan inputs through each of the scan chains 230 produces a scan output with a particular value. The compressor 240 then receives the scan outputs from each of the plurality of scan chains 230. The compressor 240 compresses the scan outputs and sends the scan outputs via output scan channels to the ATE 120. In exemplary embodiments, when automatic test equipment determines that a particular scan chain is defective on the circuit 300, the automatic test equipment programs the circuit 300, burns a fuse of the circuit 300, or sends a signal to select a particular spare scan chain to bypass the particular defective scan chain.

In some embodiments of the invention, the circuit 300 (e.g., an integrated circuit) includes a spare scan chain 330B (e.g., a bypass scan chain) for each internal scan chain 330A. In some embodiments, one, some, or all of the internal scan chains 330A can be bypassed permanently; this allows an integrated circuit chip with one or multiple defective scan chains to be salvaged by bypassing detected defective scan chains as needed. That is, in some embodiments, as many internal scan chains can be bypassed as there are spare scan chains.

Referring to FIG. 3B, some embodiments include the circuit 300, wherein the circuit 300 includes a reconfiguration mechanism implemented as the fuse box 370. In some embodiments, selection of the bypass chains comes from one or more fuses of the fuse box 370. Automatic test equipment can burn one or more particular fuses of the fuse box 370 to select bypass scan chains. In some embodiments, the fuses of the fuse box 370 are initialized with a particular default value (e.g., a bit value of zero). For example, in a default setup no scan chains are bypassed initially. When automatic test equipment identifies or detects a defective scan chain, the automatic test equipment can burn one or more fuses of the fuse box 370 which sets the bit value for the burnt fuses (e.g., a bit value of 1). Upon the automatic test equipment identifying a defective scan chain and burning the corresponding fuses of the fuse box 370, the bit value of the burnt fuse indicates to the scan chain selection mechanism (e.g., multiplexer 350) to select the spare scan chain 330B and bypass the defective scan chain (e.g., 330A).

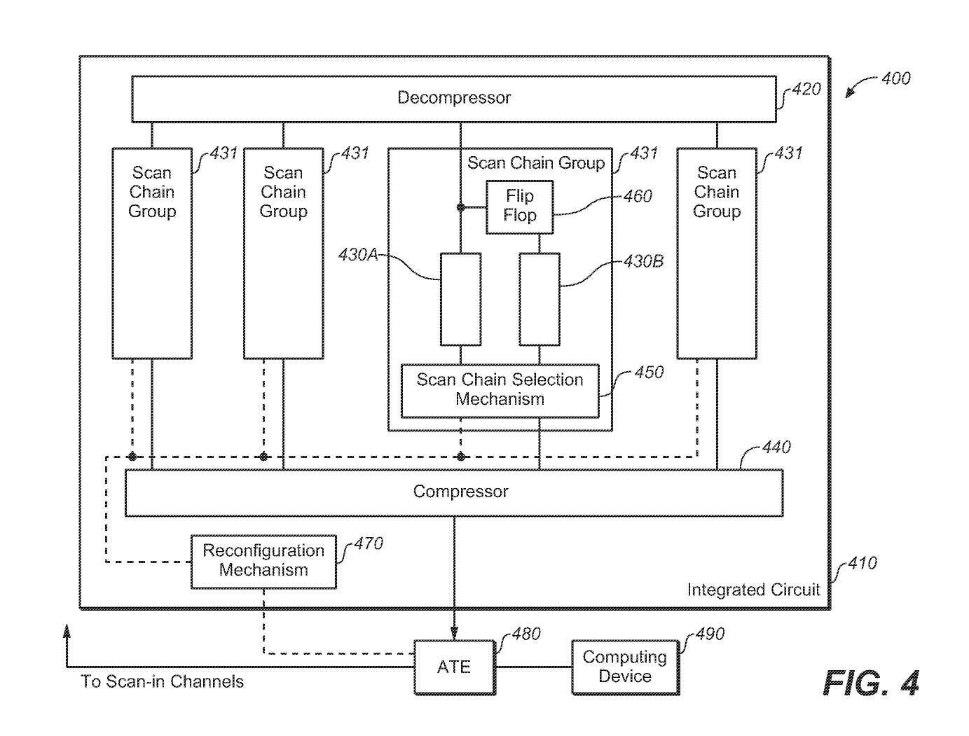

Referring to FIG. 4, diagram of an exemplary system 400 of some embodiments is depicted. In some embodiments, the exemplary system 400 includes an integrated circuit 410 and automatic test equipment 480. In some embodiments, the integrated circuit 410 includes plurality of scan channels; a decompressor 420; a plurality of scan chain groups 431; a compressor 440; one or more cores, logic circuits, other processing modules (such as core 114 as shown in FIG. 1), or the like; pins (such as pins 115, 116 as shown in FIG. 1); and a reconfiguration mechanism 470. In further embodiments, the automatic test equipment 480 is configured to communicatively connect to one or more computing devices (such as computing device 490), such as via a network, a wire, a cable, a wireless connection, or the like.

As shown in FIG. 4, in embodiments of the exemplary system 400, each scan chain group 431 of the plurality of scan chain groups 431 includes a plurality of scan chains (including at least one scan chain 430A and at least one spare scan chain 430B); at least one spare flip flop 460; and a scan chain selection mechanism 450. The scan chain 430A and the spare scan chain 430B are communicatively coupled on the scan-in side to the compressor 420 and communicatively coupled on the scan-out side to the scan chain selection mechanism 450, and the scan chain selection mechanism 450 is coupled to the compressor 440. The scan chain selection mechanism 450 is configured to select or change a particular scan chain to be used or bypassed. In some embodiments, the scan chain selection mechanism 450 passes the scan-outs of the selected scan chain to the compressor 440 based upon an indication, trigger, or electronic signal received from or passed through the reconfiguration mechanism 470.

In further embodiments, each scan chain group 431 includes a spare flip flop 460; in such embodiments, the spare flip flop 460 is coupled between the scan chain 430A and the spare scan chain 430B. In some embodiments which include an implementation with a spare flip flop 460, the scan chain group 431 includes only one spare flip flop 460; in other embodiments, the scan chain group 431 includes two or more spare flip flops. In still further embodiments, each scan chain group 431 also includes a scan chain selection mechanism 450 (such as multiplexer 350 depicted in FIGS. 3A and 3B); in such embodiments, the scan-out sides of the scan chain 430A and the spare scan chain 430B are coupled to the scan chain selection mechanism 450, which is coupled to the compressor 440.

For example, in some embodiments, the scan chain selection mechanism 450 comprises a multiplexer (such as the multiplexer 350 described in reference to and depicted in FIGS. 3A and 3B).

In some embodiments, the reconfiguration mechanism 470 comprises a fuse box or fuses (such as described in reference to and depicted in FIGS. 1 and 3B) or a solid state memory circuit. In further embodiments, selection of the default scan chain 430A or the spare scan chain 430B is switchable, controllable, programmable, or reprogrammable. For example, in some embodiments, the reconfiguration mechanism 470 includes a programmable solid state memory circuit configured to store one or more bit values associated with a particular scan chain group 431, multiple scan chain groups 431, a particular scan chain selection mechanism 450, and/or multiple scan chain selection mechanisms 450. For example, automatic test equipment 480 can program a value in a solid state memory circuit, and the value stored by the solid state memory circuit is passed to the scan chain selection mechanism 450 (e.g., a multiplexer) of the scan chain group to select a particular scan chain of the scan chain group 431.

In some embodiments, the automatic testing equipment is configured to perform default testing with test patterns generated from a default setup, which is configured for the default scenario or mode. In the default mode no default scan chains are bypassed. Bypass/spare scan chains (and/or spare flip flops) are only used in the shift mode and can retain values in capture. The automatic testing equipment 480 is configured to detect and identify any defective scan chains. Upon identifying a particular defective scan chain, the automatic test equipment 480 determines whether (or verifies) that the silicon is salvageable (e.g., potentially functional except for one or more bypassable defective scan chains).

In some embodiments, if the automatic testing equipment identifies 480 one or more defective scan chains, the automatic testing equipment 480 performs modified testing with regenerated test patterns according to a modified setup. The modified testing according to the modified setup can include creating and performing a fuse burning test to burn the appropriate fuses for the appropriate bypass scan chains; furthermore, upon creation or performance of the fuse burning test, the automatic testing equipment burns the appropriate fuses. Upon burning the appropriate fuses, the automatic testing equipment modifies the test generation setup to include a fuse read corresponding to bypassing the defective scan chain (with the spare/bypass scan chain).

Additionally, in some embodiments, patterns are regenerated with select lines (such as select lines of a scan chain selection mechanism 450) asserted to the appropriate bypass chains. In further embodiments, the computing device 490 (or the automatic testing equipment 480) then performs simulations on the regenerated patterns, and the regenerated patterns can be sent to the automatic testing equipment 480 for running on the existing silicon (e.g., the silicon with at least one bypassed or bypassable defective scan chains). Additionally, some embodiments include performing a timing analysis so that scan shift operation is properly performed and timed for scans through any spare scan chains 430B and/or spare flip flops 460. In further embodiments, the timing analysis includes performing testing upon completing the selection of spare scan chains (e.g., scan chains set to bypass defective scan chains) to verify, calculate, or determine any timing effects. Additionally, some embodiments include a clock (e.g., a dedicated clock or a shared clock) to account for shift caused by using spare scan chains which pass through the one or more spare flip flops; in some implementations, the clock can be used during test setup to account for proper timing and turned off during the remainder of a particular testing and scanning process.

Additionally, some embodiments of the invention include scan chains selection mechanisms (such as multiplexing structures) on scan paths going into the compressor. Additionally, in some embodiments, more than one scan chain goes into a particular scan chain selection mechanism (such as a multiplexing structure). Furthermore, some embodiments have an absence of scan chains going directly into the compressor. In some embodiments, the select lines of the scan chain selection mechanism (e.g., a multiplexer or a multiplexing structure) come from a fuse box or a scan chain. Additionally, in some embodiments, there are multiple fanned-out paths (e.g., split offs) for a decompressor output to a particular scan chain group.

In alternative embodiments, an integrated circuit which includes a plurality of scan chain groups can be implemented without a reconfiguration mechanism (such as a fuse box). In such alternative embodiments, each of the scan chain groups includes a default scan chain, a spare scan chain, a first spare flip flop, a second spare flip flop, and a scan chain selection mechanism (e.g., a multiplexer). In such alternative embodiments, the default scan chain, the spare scan chain, the first spare flip flop, and the scan chain selection mechanism are configured similarly to the other embodiments described throughout; however, in such alternative embodiments, the second spare flip flop is configured to setup the select lines of the scan chain selection mechanism (e.g., multiplexer). In some of these alternative embodiments, each of the second spare flip flops is a non-scan type flip flop and is concatenated to form part of the scan chain group or default scan chain; for example, the second spare flip flop can be prepended, appended, or linked to the scan-in side of the scan chain group; prepended, appended, or linked to the first spare flip flop; prepended, appended, or linked to the default scan chain; or the like). In some implementations of the alternative embodiments, the second spare flip flops are driven by a dedicated clock and scanned during test setup; and the dedicated clock can be turned off for the remainder of the testing and scanning process such that the second spare flip flops retain their values. According to such alternative embodiments, the second spare flips have a similar functionality of the reconfiguration mechanism (e.g., a fuse box) of other described embodiments such that the second spare flip flops are configured to setup the select lines of the scan chain selection mechanisms (e.g., multiplexers). Furthermore, in the alternative embodiments (with the first spare flip flops and second spare flip flops), there is no functional impact on timing because only the scan shift paths are affected. Additionally, in the alternative embodiments, the scan-in of a particular multiplexer select scan chain does not require a dedicated input from a reconfiguration mechanism.

In a particular exemplary implementation, an integrated circuit includes 756 scan chain groups with a total of 3,049,672 primitives. In the particular exemplary implementation, the integrated circuit includes 756 scan chain groups, a decompressor, a compressor, and a reconfiguration mechanism, as well as other components or circuitry. Each scan chain group of the particular exemplary implementation includes a default scan chain, a spare scan chain, a spare flip flop, and a multiplexer. While the foregoing particular exemplary implementation is described with 756 scan chain groups, it is fully contemplated that embodiments or implementations can include any number of scan chain groups, scan chains, spare scan chains, spare flip flops, scan chain selection mechanisms (e.g., multiplexers), or the like.

In an alternative exemplary implementation, an integrated circuit includes 756 scan chain groups with a total of 3,049,672 primitives. In the particular exemplary implementation, the integrated circuit includes 756 scan chain groups, a decompressor, a compressor, as well as other components or circuitry. Each scan chain group of the particular exemplary implementation includes a default scan chain, a spare scan chain, a first spare flip flop, a second spare flip flop, and a multiplexer. While the foregoing alternative exemplary implementation is described as having 756 default scan chains, 756 spare scan chains, 756 first spare flip flops, 756 second spare flip flops, and 756 multiplexers, it is fully contemplated that embodiments or implementations can include any number of scan chain groups, scan chains, spare scan chains, first spare flip flops, second spare flip flops, scan chain selection mechanisms (e.g., multiplexers), or the like. Furthermore, the additional chip area overhead for the integrated circuit of the alternative exemplary implementation (e.g., 756 first spare flip flops and 756 second spare flip flops) only requires 0.075% more chip area as compared to the integrated circuit of the particular exemplary implementation (e.g., with 756 spare flip flops).

It is believed that other embodiments of the invention will be understood by the foregoing description, and it will be apparent that various changes can be made in the form, construction, and arrangement of the components thereof without departing from the scope and spirit of embodiments of the invention or without sacrificing all of its material advantages. The form herein described is merely an explanatory embodiment thereof, and it is the intention of the following claims to encompass and include such changes.

What is claimed is:

1. A system, comprising:
an integrated circuit, wherein the integrated circuit includes:
at least one scan chain group, wherein a particular scan chain group of the at least one scan chain group includes:
at least one scan chain, the at least one scan chain including a particular scan chain; and
at least one spare scan chain, the at least one spare scan chain including a particular spare scan chain configured to bypass the particular scan chain.

2. The system of claim 1, wherein the particular scan chain is defective and wherein the particular spare scan chain is selected to bypass the defective particular scan chain.

3. The system of claim 1, wherein the particular scan chain group further includes a spare flip flop.

4. The system of claim 3, wherein the particular scan chain group further includes a second spare flip flop.

5. The system of claim 1, wherein the particular scan chain group further includes a scan chain selection mechanism.

6. The system of claim 5, wherein the scan chain selection mechanism comprises a multiplexer.

7. The system of claim 5, wherein the scan chain selection mechanism is configured for selecting an output to send to a compressor from one of the particular scan chain or the particular spare scan chain based upon an output from a reconfiguration mechanism.

8. The system of claim 5, wherein the scan chain selection mechanism is configured for selecting an output to send to a compressor from one of the particular scan chain or the particular spare scan chain based upon a received output from one of the particular scan chain or the particular spare scan chain.

9. The system of claim 5, wherein the scan chain selection mechanism is configured for selecting a scan chain output from the particular scan chain or the particular spare scan chain.

10. The system of claim 1, further comprising a decompressor.

11. The system of claim 1, further comprising a compressor.

12. The system of claim 1, further comprising a reconfiguration mechanism.

13. The system of claim 13, wherein the reconfiguration mechanism includes at least one fuse, wherein burning one or more of the at least one fuse selects one of the particular spare scan chain or the particular scan chain.

14. The system of claim 1, wherein the at least one scan chain group includes a first scan chain group and a second scan chain group, wherein each of the first scan chain group and the second scan chain group includes at least one defective scan chain and at least one functional scan chain, wherein the at least one defective scan chain of the first scan chain group and the at least one defective scan chain of the second scan chain group are bypassed.

15. The system of claim 1, wherein the particular scan chain is a compression scan chain and the particular spare scan chain is a spare compression scan chain.

16. The system of claim 1, further comprising:
automatic test equipment, the automatic test equipment configured for testing the integrated circuit and reconfiguring compression logic of the integrated circuit.

17. The system of claim 1, further comprising:
automatic test equipment, the automatic test equipment configured to couple to the integrated circuit, wherein the automatic test equipment is further configured for:
sending scan chain inputs to scan channels of the integrated circuit;
receiving scan chain outputs from the integrated circuit;
detecting at least one defective scan chain of the integrated circuit; and
sending a scan chain reconfigure signal to the integrated circuit.

18. An integrated circuit, comprising:
a decompressor;
a compressor; and
at least one scan chain group, wherein a particular scan chain group of the at least one scan chain group includes:
at least one scan chain, the at least one scan chain including a particular scan chain;
at least one spare scan chain, the at least one spare scan chain including a particular spare scan chain configured to bypass the particular scan chain;
a spare flip flop connected to the particular spare scan chain; and
a multiplexer, the multiplexer being coupled to the particular scan chain and the particular spare scan chain, wherein the multiplexer is configured for selecting a scan chain output from the particular scan chain or the particular spare scan chain and outputting the selected scan chain output to the compressor.

19. The integrated circuit of claim 18, further comprising a fuse box.

20. An integrated circuit, comprising:
a decompressor;
a compressor; and
at least one scan chain group, wherein a particular scan chain group of the at least one scan chain group includes:
at least one scan chain, the at least one scan chain including a particular scan chain;
at least one spare scan chain, the at least one spare scan chain including a particular spare scan chain configured to bypass the particular scan chain;
a first spare flip flop connected to the particular spare scan chain; and
a multiplexer, the multiplexer being coupled to the particular scan chain and the particular spare scan chain, the multiplexer being further coupled to the compressor, wherein the multiplexer is configured for selecting a scan chain output from the particular scan chain or the particular spare scan chain and outputting the selected scan chain output to the compressor; and
a second spare flip flop, the second spare flip coupled to at least one of the decompressor, the particular scan chain, the particular spare scan chain, or the first spare flip flop.
